(19) United States
(12) Patent Application Publication
(10) Pub. No.: US 2008/0225893 A1
(43) Pub. Date: Sep. 18, 2008

(54) ACKNOWLEDGED MODE RADIO LINK CONTROL ARCHITECTURE AND METHOD WITHIN EVOLVED HSPA SYSTEMS

(75) Inventors: Christopher R. Cave, Verdun (CA); Diana Pani, Montreal (CA); Sudheer A. Grandhi, Mamaroneck, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/049,155

(22) Filed: Mar. 14, 2008

Related U.S. Application Data
(60) Provisional application No. 60/895,208, filed on Mar. 16, 2007.

(51) Int. Cl. H04L 29/06

(52) U.S. Cl. 370/476

(57) ABSTRACT

An acknowledged mode (AM) radio link control (RLC) architecture and method within evolved high speed packet access (HSPA) are disclosed. The RLC is configured to operate in AM and process protocol data units (PDUs) of flexible size. Specifically, an AM RLC architecture and method in which RLC SDUs are segmented and/or concatenated only at the time of or immediately prior to delivering the PDUs to lower layers. This includes an interface with lower layers in order to support flexible PDU sizes for AM RLC.

### CROSS REFERENCE TO RELATED APPLICATIONS

This application claims the benefit of U.S. provisional application No. 60/895,208 filed Mar. 16, 2007, which is incorporated by reference as if fully set forth.

### FIELD OF INVENTION

This application is related to wireless communications.

### BACKGROUND

The Radio Link Control (RLC) Protocol is a Level 2 (L2) protocol within 3GPP Universal Mobile Telecommunication Systems (UMTS) that provides segmentation, retransmission and flow control services for control and user data. The RLC can be configured to operate in Transparent Mode (TM), Unacknowledged Mode (UM) and Acknowledged Mode (AM). TM RLC functions include the transfer of user data and segmentation and reassembly functionalities. UM RLC functions include the transfer of user data, segmentation and reassembly functionalities, ciphering and sequencing. The AM RLC provides reliability through retransmission. AM RLC functions include transfer of user data, segmentation and reassembly functionalities, error correction, duplicate detection, protocol error detection and recovery, and ciphering. The AM RLC includes an Automatic Repeat Request (ARQ) function that provides error correction for services requiring higher transmission reliability, such as packet-switched data services. FIG. 1 shows a detailed block diagram of a typical AM RLC architecture.

More recently, enhancements to the AM RLC have been proposed as part of 3GPP Release 7 standardization efforts. Flexible protocol data unit (PDU) sizes for AM RLC have been introduced as an enhancement to 3GPP Release 6 standards where the AM RLC is configured by higher layers to operate with a single PDU size. This is expected to reduce the possibility of the RLC stalling at high data rates, where the RLC has been shown to be a throughput bottleneck.

The improved AM RLC is configured to operate with a maximum PDU size rather than a fixed PDU size, and hence should only segment service data units (SDUs) that are larger than the maximum PDU size. The RLC PDUs will then be segmented and/or concatenated at the new enhanced high speed medium access control (MAC-ehs) layer in the Node-B in the downlink, where an ideal transport block size is selected based on instantaneous channel conditions.

The existing 3GPP Release 6 AM RLC architecture, as shown in the prior art in FIG. 1, delivers fixed length PDUs to lower layers for transmission over the air interface. The fixed PDU size is a semi-static parameter that is configured by higher layers. In order to modify the fixed PDU size, an RLC re-establishment procedure must be performed, which can cause the loss of SDUs.

With flexible AM RLC PDU sizes, the transmitting RLC should be capable of delivering PDUs of variable size as long as they are configured within the limit imposed by a maximum AM RLC PDU size. The maximum RLC PDU size should be reconfigurable without any additional impact such as SDU loss or delay. The existing AM RLC model does not adequately support seamless reconfiguration of the maximum RLC PDU size. Moreover, other elementary RLC procedures as well as the interface to lower layers should be optimized considering the introduction of flexible PDU sizes.

### SUMMARY

An acknowledged mode (AM) radio link control (RLC) architecture and method within evolved high speed packet access (HSPA) are disclosed. Specifically, an AM RLC architecture and method in which RLC SDUs are segmented and/or concatenated at the time of, or immediately prior to, delivering the PDUs to lower layers. This includes an interface with lower layers in order to support flexible PDU sizes for AM RLC.

### BRIEF DESCRIPTION OF THE DRAWINGS

A more detailed understanding may be had from the following description, given by way of example in conjunction with the accompanying drawings wherein:

FIG. 1 is an example block diagram of the RLC AM as in the prior art;

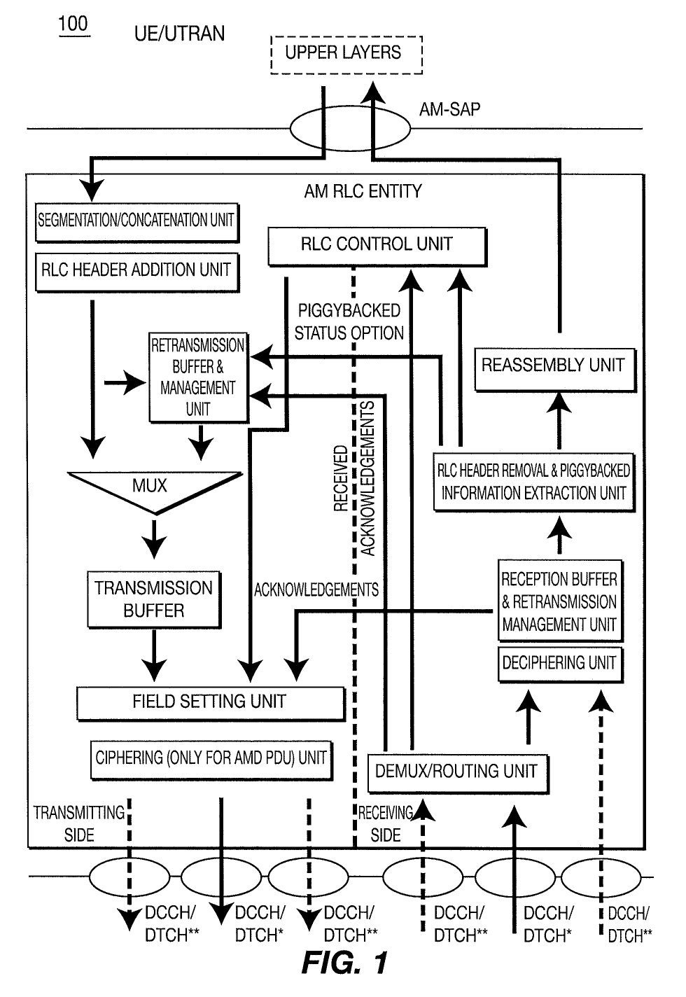

FIG. 2 is an example block diagram of an AM RLC architecture in accordance with one embodiment;

FIG. 3 is an example block diagram of an AM RLC architecture in accordance with an alternative embodiment;

FIG. 4 is an example block diagram of an AM RLC architecture in accordance with an alternative embodiment;

FIG. 5 is a flow diagram of the AM RLC method performed at the transmitting side; and

FIG. 6 is a flow diagram of the AM RLC method performed at the receiving side.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

In accordance with one embodiment, a new acknowledged mode (AM) radio link control (RLC) architecture that supports the creation of flexible protocol data unit (PDU) sizes is disclosed. Specifically, the RLC service data units (SDUs) are only segmented and/or concatenated at the time of or immediately prior to delivering the PDUs to lower layers. Other new AM RLC procedures, as well as a new interface with lower layers are included in order to more adequately support the generation of flexible PDU sizes for the AM RLC. Although the procedures described below relate to the downlink (DL) operation of the AM RLC, the concepts are also applicable to the uplink (UL) operation of the AM RLC. The descriptions below assume that the RLC has enough data to create a full size PDU, i.e., of size requested by lower layers or of maximum size determined by radio resource control (RRC) layer. It is possible the RLC may only contain a small amount of buffered data in which case it would create a PDU that is smaller than the requested size or smaller than the maximum size.

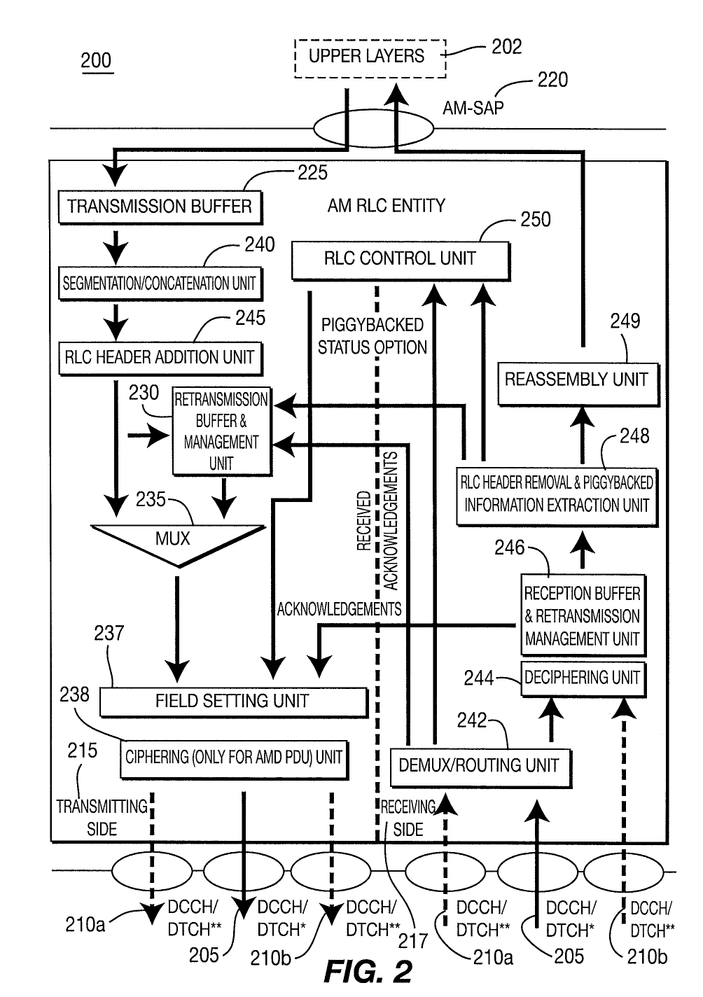

FIG. 2 is a block diagram of the AM RLC entity 200 in accordance with one embodiment. The AM RLC entity 200 includes a transmitting side 215 and a receiving side 217. In FIG. 2, one logical channel 205 (shown as a solid line) and two logical channels 210a and 210b (shown as dashed lines) are shown.

The transmitting side 215 of the AM RLC entity 200 receives RLC SDUs from upper layers 202, through the acknowledged mode service access point (AM SAP) 220 and includes a transmission buffer 225, a retransmission and buffer management unit 230, a multiplexer 235 (MUX), a field setting unit 237 to set fields in the PDU header (e.g., set poll bits) and piggybacked STATUS PDU, a ciphering unit 238, a segmentation/concatenation unit 240, and an RLC header addition unit 245. The receiving side 217 of the AM RLC entity 200 receives AMD and Control PDUs through the configured logical channels, one logical channel 205 (shown as a solid line) and two logical channels 210a and 210b (shown as dashed lines), from the lower layer. The receiving side 217 includes a demultiplexing/routing unit 242, a deciphering unit 244, a reception buffer and retransmission management unit 246, an RLC header removal and piggybacked information extraction unit 248 and a reassembly unit 249. An RLC Control unit 250 manages the functions between the transmitting side 215 and the receiving side 217.

If flexible PDU sizes are configured, the RLC SDUs are buffered in a transmission buffer 225. If a fixed RLC PDU size is configured, RLC SDUs are segmented and/or concatenated into acknowledged mode data (AMD) PDUs of a fixed length. Segmentation is performed if the received RLC SDU is larger than the length of available space in the AMD PDU. The AMD PDU size may be a semi-static value that is configured by upper layers and can be changed through re-establishment of the AM RLC entity by upper layers.

If a flexible RLC PDU size is configured, one or more RLC SDUs are removed from the transmission buffer 225 prior to creation of the PDU or PDUs requested by lower layers. RLC SDUs are segmented if the SDU is larger than the maximum RLC PDU size configured by upper layers. Concatenation may be performed up to the maximum RLC PDU size. The maximum RLC PDU size is a semi-static variable that is configured in the transmitting side 215 by upper layers. The flexible RLC PDU size can be configured in either the uplink or the downlink. Alternatively, the RLC SDUs may be segmented if the SDU is larger than the maximum RLC PDU size that is requested by lower layers (MAC sub-layer). The maximum RLC PDU size that is requested by lower layers should be lower than the than the maximum RLC PDU size configured by upper layers.

The AMD PDU may contain segmented and/or concatenated RLC SDUs. The AMD PDU may also contain padding to ensure that it is of a valid size. Where fixed RLC PDU size is configured, a valid size would correspond to the configured fixed RLC PDU size. Where flexible RLC PDU size is configured, the valid size corresponds to an octet aligned RLC PDU size. For example, if there are only 317 bits of available data, 3 padding bits would have to be added to make the RLC PDU octet aligned. The padding may also apply in the scenario when a minimum RLC PDU payload size is specified by the upper layers. If a fixed RLC PDU size is configured, length indicators may be used to define boundaries between RLC SDUs within AMD PDUs. Length indicators may also be used to define whether a padding or piggybacked STATUS PDU is included in the AMD PDU. A piggybacked STATUS PDU would be included when a STATUS PDU has been created and there is enough available free space in the RLC PDU that is to be transmitted at that time. If the RLC does not have enough data to fit the requested PDU size or the maximum PDU size, it will add the STATUS PDU. If a flexible RLC PDU size is configured, the length indicator size may be configured by upper layers 202.

After the segmentation and/or concatenation is performed, the AMD PDUs may be placed in the retransmission buffer 230 and at the multiplexer (MUX) 235. Also, separate buffers (not shown) may be maintained for new and re-transmission PDUs.

AMD PDUs buffered in the retransmission buffer 230 are deleted or retransmitted based on the status report found within a STATUS PDU or piggybacked STATUS PDU sent by a peer AM RLC entity. This status report may contain positive or negative acknowledgements of individual AMD PDUs received by the peer AM RLC entity.

The multiplexer (MUX) 235 multiplexes AMD PDUs from the retransmission buffer 230. The multiplexed AMD PDUs may be retransmitted and the newly generated AMD PDUs delivered from the segmentation/concatenation function 240.

The PDUs are delivered to the RLC header addition unit 245 to complete the AMD PDU header and preferably replace padding with piggybacked status information. Piggybacked STATUS PDUs can be of variable size in order to match the amount of free space in the AMD PDU. The AMD PDU header is completed based on the input from the RLC control unit 250 that indicates the values to set in various fields, such as a polling bit. The function may multiplex control PDUs received from the RLC control unit 250, such as RESET and RESET ACK PDUs, and from the reception buffer, such as piggybacked STATUS and STATUS PDUs, with AMD PDUs.

The ciphering may be applied to the AMD PDUs. The AMD PDU header is not ciphered. Piggybacked STATUS PDU and padding in AMD PDU may be ciphered. Control PDUs, such as, STATUS PDU, RESET PDU, and RESET ACK PDU, are not ciphered.

The transmitting side of the AM RLC entity 215 submits AMD PDUs to the lower layer through either one or two dedicated control channels (DCCH) or a dedicated traffic channel (DTCH).

RLC SDUs should remain intact in a transmission buffer for as long as possible until the RLC can deliver the PDUs to lower layers for transmission. The existing SDU discard procedures described in prior systems are applicable to the SDU transmission buffer where the RLC SDUs may be discarded when an RLC PDU (which contains the SDU or a segment of the SDU) has exceeded the maximum number of retransmissions or when an SDU discard timer has expired. More specifically, for the latter, for every SDU received from a higher layer, a timer_discard is started. This controls maximum RLC SDU delays.

Preferably, the medium access control (MAC) sub-layer should decide how many bytes shall be transmitted by the AM RLC in each transmission time interval (TTI). The interface between the AM RLC and lower layers is discussed below.

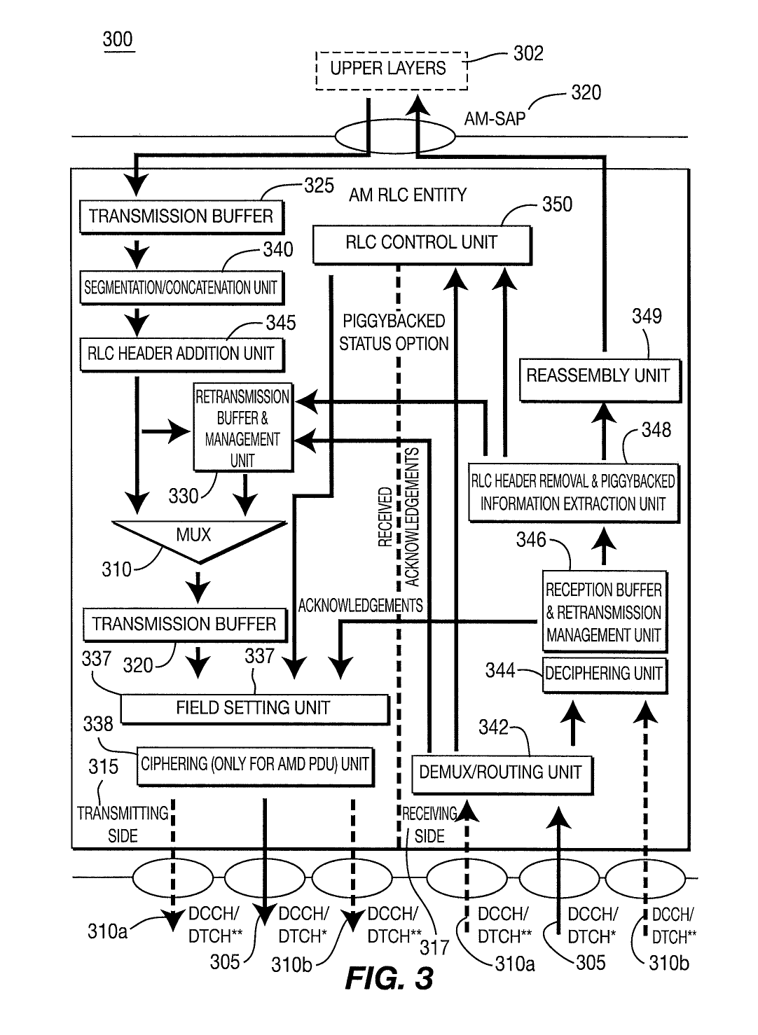

FIG. 3 is an alternative embodiment of an AM RLC architecture 300. The AM RLC entity 300 includes a transmitting side 315 and a receiving side 317. In FIG. 3, one logical channel 305 (shown as a solid line) and two logical channels 310a and 310b (shown as dashed lines) are shown.

The transmitting side 315 of the AM RLC entity 300 receives RLC SDUs from upper layers 302, through the acknowledged mode service access point (AM SAP) 320 and includes a transmission buffer 325, a retransmission and buffer management unit 330, a multiplexer 335 (MUX), a field setting unit 337 to set fields in the PDU header (e.g., set poll bits) and piggybacked STATUS PDU, a ciphering unit 338, a segmentation/concatenation unit 340, and an RLC header addition unit 345. The receiving side 317 of the AM RLC entity 300 receives AMD and Control PDUs through the configured logical channels, one logical channel 305 (shown as a solid line) and two logical channels 310a and 310b (shown as dashed lines), from the lower layer. The receiving side 317 includes a demultiplexing/routing unit 342, a deciphering unit 344, a reception buffer and retransmission management unit 346, an RLC header removal and piggybacked information extraction unit 348 and a reassembly unit 349. In this alternative embodiment, a transmission buffer 312 can be included after the MUX 335 on the transmitting side 315 where RLC PDUs may be temporarily stored prior to setting fields in the header, ciphering and delivering to lower layers. An RLC Control unit 350 manages the functions between the transmitting side 315 and the receiving side 317.

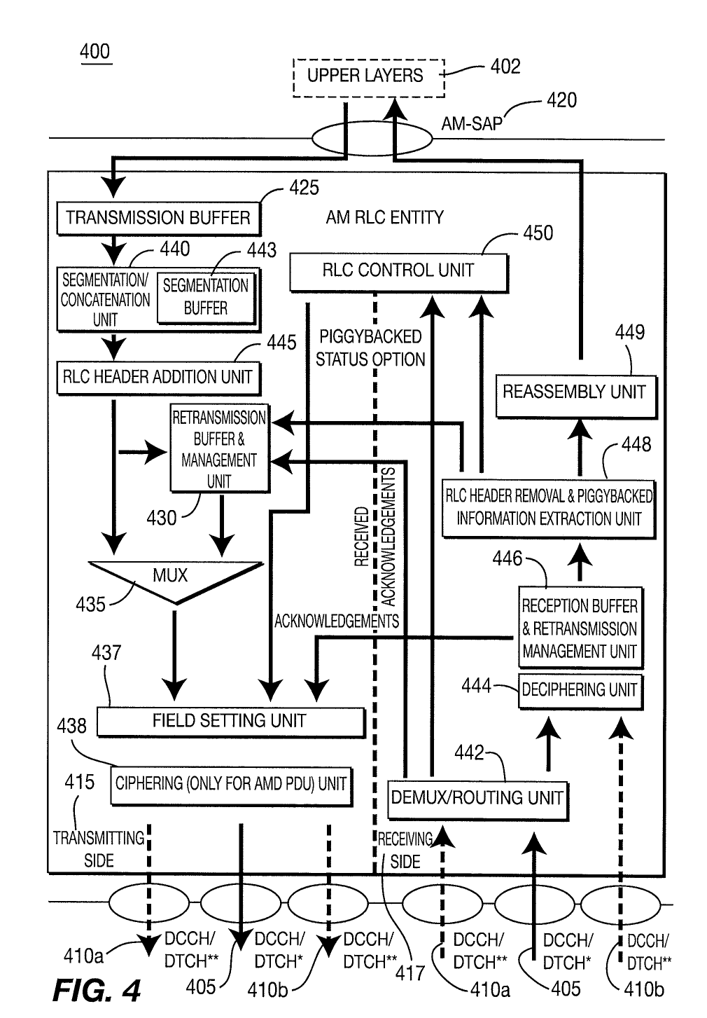

FIG. 4 is an alternative embodiment of an AM RLC architecture 400. The AM RLC entity 400 includes a transmitting side 415 and a receiving side 417. In FIG. 4, one logical channel 405 (shown as a solid line) and two logical channels 410a and 410b (shown as dashed lines) are shown.

The transmitting side 415 of the AM RLC entity 400 receives RLC SDUs from upper layers 402, through the acknowledged mode service access point (AM SAP) 420 and includes a transmission buffer 425, a retransmission and buffer management unit 430, a multiplexer 335 (MUX), a field setting unit 437 to set fields in the PDU header (e.g., set poll bits) and piggybacked STATUS PDU, a ciphering unit 438, a segmentation/concatenation unit 440, and an RLC header addition unit 445. The receiving side 417 of the AM RLC entity 400 receives AMD and Control PDUs through the configured logical channels, one logical channel 405 (shown as a solid line) and two logical channels 410a and 410b (shown as dashed lines), from the lower layer. The receiving side 417 includes a demultiplexing/routing unit 442, a deciphering unit 444, a reception buffer and retransmission management unit 446, an RLC header removal and piggybacked information extraction unit 448 and a reassembly unit 449. In this alternative embodiment, a segmentation buffer 443 is included in the segmentation/concatenation unit 440. An RLC Control unit 450 manages the functions between the transmitting side 415 and the receiving side 417.

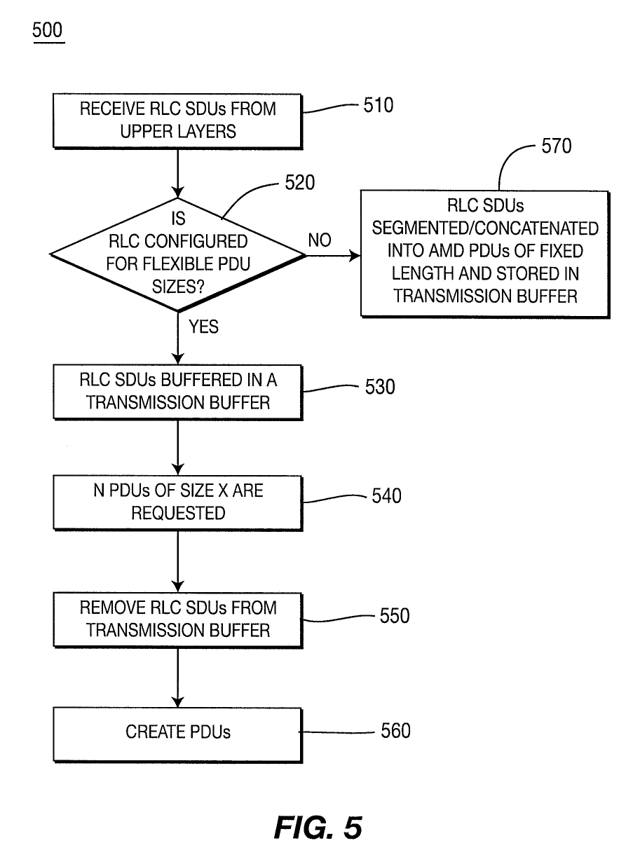

FIG. 5 is a flow diagram of the AM RLC procedure 500 performed at the transmitting side 215 of the AM RLC entity of FIG. 2. The transmitting side 215 of the AM RLC entity 200 receives RLC SDUs from the upper layers through the AM service access point 220 (SAP) at 510. If flexible PDU sizes are configured at 520, the RLC SDUs are buffered in a transmission buffer 225 at 530. Subsequently, N PDUs of size X are requested at 540. Alternatively, a maximum RLC PDU size could be requested by lower layers or a maximum amount of bits could be requested by lower layers. The RLC SDUs are then removed from the transmission buffer 225 at 550. Finally, the PDUs are created at 560.

If a fixed RLC PDU size is configured at 520, the RLC SDUs are segmented and/or concatenated by the segmentation/concatenation unit 240 into acknowledged mode data AMD PDUs of a fixed length and stored in a transmission buffer 225 at 570. The segmentation is performed if the received RLC SDU is larger than the length of available space in the AMD PDU.

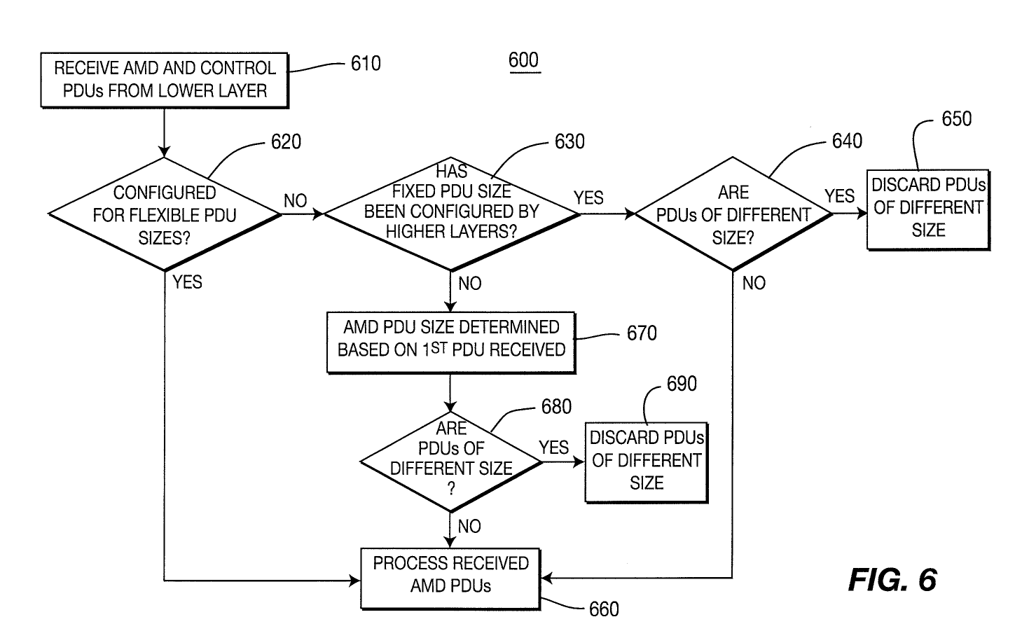

FIG. 6 is a flow diagram of the AM RLC method 600 performed at the receiving side. When receiving RLC PDUs, the receiving side of the AM RLC should only discard or ignore PDUs that are of different size than the configured “downlink AMD PDU size” if “fixed RLC PDU size” has been configured. Also, if “flexible RLC PDU size” has been configured, all PDUs with valid header are processed by the receiving side 217.

The receiving side 217 of the AM RLC entity 200 of FIG. 2 receives AMD and Control PDUs through the configured logical channels from the lower layer at 610. If a flexible PDU size is configured at 620, the received AMD PDUs are processed at 660.

If fixed RLC PDU size is configured at 620, a determination of whether a fixed PDU size has been configured by higher layers is performed at 630. If the fixed PDU size has been configured by higher layers, a determination of whether the PDUs are of different size is performed at 640. If the PDUs are of different size at 640, the PDUs of different size are discarded at 650. If the PDUs are of the same size at 640, the received AMD PDUs are processed at 660.

If the fixed PDU size has not been configured by higher layers at 630, the AMD PDU size is determined based on the first PDU received at 670. A determination is then made to check if the PDUs are of different size at 680. If the PDUs are determined to be of different size at 680, the PDUs of different size are discarded at 690.

The maximum AM RLC PDU size is configurable by higher layers. The maximum AM RLC PDU size should be dynamically reconfigurable without any disruption or loss of data.

When the RLC indicates a change of maximum RLC PDU size by higher layers, the RLC, for all retransmitted RLC PDUs, ignores the new maximum PDU size and retransmits PDUs containing the same payload units as in the first transmission. Also, the RLC, for any other RLC PDU that has not yet been transmitted or delivered to lower layers for information transfer service may extract the SDUs and/or SDU segments contained in the PDU and recreate a new RLC PDU according to the new maximum RLC PDU size. Alternatively, the AM RLC may ignore the new maximum PDU payload size and retain the existing RLC PDUs that have already been constructed.

For unprocessed RLC SDUs that are stored in the transmission buffer 225, prior to the segmentation/concatenation function 240, the RLC will segment and/or concatenate the SDUs using the new maximum RLC PDU size.

The existing interface between RLC and MAC sub-layers is defined in prior systems. The existing MAC primitives, used for AM RLC, indicate to the RLC entity the number of PDUs the MAC is requesting to be transmitted at the given time. Since there was only one fixed size available, the MAC only requested a number of PDUs of the configured size. The primitives are preferably modified. The MAC-DATA-Indication primitive, which is used by the receiving MAC to indicate the reception of a RLC PDU, should include the PDU size, either measured in bits or in octets, of each RLC PDU that has been received. Alternatively, the total size or the sum of the sizes of individual RLC PDUs received can be indicated, measured in bits or octets. In another alternative, the size of the received transport block can be indicated.

The MAC-STATUS-Indication primitive, which indicates to the RLC on the transmitting side 215, for each logical channel, the rate at which it may transfer data to the MAC, should include the maximum number of bits or octets that can be delivered to the MAC for information transfer service. The maximum size parameter, measured in bits or octets, corresponds to the sum of all RLC PDUs that are delivered to the MAC, preferably per transmission time interval. Alternatively, the maximum size parameter could be interpreted as the maximum amount of data that the RLC can deliver to the MAC over any other fixed period of time. In another alternative, the maximum size parameter can be interpreted as the amount of data that the RLC can deliver until the next time a maximum size is indicated using the MAC-STATUS-Indication primitive. Alternatively, the MAC layer can request for N PDUs of size X from the RLC, in which case the parameters N and X would be included in the MAC-STATUS-Indication primitive. The MAC layer can determine the amount of data to request from the RLC based as the amount of data that can be transmitted or is expected to be transmitted during the next TTI or subsequent TTIs. The amount of data that can be transmitted over the air interface during a Transmission Time Interval (TTI) depends on the radio channel conditions and scheduling between different WTRUs.

Upon initial setup, addition or reconfiguration of an RLC instance, the MAC-hs should be configured accordingly. The MAC-hs is configured by higher layers, specifically the radio resource controller (RRC). The RRC procedure that deals with the configuration or reconfiguration of the MAC-hs queues and the MAC-d flows is described in prior systems. However, this procedure requires modification.

The modification is dependent on the mapping of MAC-d flows and logical channels. One alternative is one to one mapping between logical channels and MAC-d flows. Another alternative is the multiplexing of logical channels in one MAC-d flow where the LCH-ID is provided by the lub frame protocol.

The procedure may also be dependent on optimizations of the MAC headers that support flexible and fixed RLC PDU. MAC header optimization provides the ability of the MAC to deal with both fixed and flexible RLC PDUs. This implies that MAC header information varies based on the logical channel. If PDU size is flexible, a length indicator “LI” is provided for the SDU belonging to this logical channel. Alternatively, if the PDU size is fixed, a size indicator “SID” and “N”, where N is the number of PDUs included in the MAC of the given size indicated by the SID field, may be provided.

In an alternate embodiment, all logical channels have a one to one mapping to the MAC-d flows. In addition, no optimization to the MAC headers is supported. This implies that all MAC SDUs will be handled the same way regardless of whether the RLC configuration is fixed or flexible.

Currently, up to eight (8) MAC-d flows are allowed for the downlink. Up to 16 logical channels can be available. Therefore, this would require that the number of DL MAC-d flow be increased to 16.

In addition, the normal MAC-hs allows a MAC-d flow to be mapped to more than one queue. However, a MAC-hs queue can only have one MAC-d flow mapped to it. By increasing the numbers of MAC-d flows to 16, the MAC-hs queue preferably allows mapping of more than one MAC-d flow.

The radio resource control (RRC) procedures corresponding to radio bearers and configuring the MAC-d flows to a MAC-ehs should also be modified. An information element (IE) for MAC-d flow identity that supports up to 16 identities is included. The IE “RB mapping info” should be modified to support mapping of logical channels to one of the 16 MAC-d flows. The IE “Added or reconfigured MAC-d flow” should be modified, including the actions related to it, in order to support mapping of different MAC-d flows to one priority queue.

A new MAC-d flow identity information element is included. The MAC-d flow identity is “DL enhanced MAC-d flow identity”. The definition of this IE is shown in Table 1 below.

TABLE 1

| Information Element/Group | | | Type and | Semantics |
|---|---|---|---|---|
| name | Need | Multi | reference | description |
| DL MAC-d flow identity | MP | | Integer | |
| | | | (0..15) | |

When configuring or re-configuring the radio bearers, the logical channel associated to this radio bearer is mapped to the correct MAC-d flow identity. In a system that does not support flexible RLC PDUs and the enhanced MAC-ehs, the logical channel can be mapped to one of the 8 MAC-d flows, however for a system that supports flexible RLC PDUs and the enhanced MAC-ehs, the logical channel preferably is mapped to one of the new 16 MAC-d flows. This should be reflected in the IE “RB mapping info”.

Preferably, the choice of mapping is done based on MAC-hs configuration (normal or enhanced) or DL RLC configuration (normal or enhanced). A definition of the RB mapping info IE is shown below in Table 2.

TABLE 2

| Information Element/Group | | | Type and | Semantics |
|---|---|---|---|---|
| name | Need | Multi | reference | description |
| Information for each multiplexing | MP | 1 to | | |
| option | | <maxRBMuxOptions> | | |
| >Downlink RLC logical channel | CV-DL-RLC | | | |
| info | info | | | |
| >>Number of downlink RLC logical | MD | 1 to | | 1 or 2 logical |
| channels | | MaxLoCHperRLC | | channels per RLC |
| | | | | entity or radio |
| | | | | bearer RLC |
| | | | | Default value is |
| | | | | that parameter |
| | | | | values for DL are |
| | | | | exactly the same as |
| | | | | for corresponding |
| | | | | UL logical channel. |
| | | | | In case two |
| | | | | multiplexing |
| | | | | options are |
| | | | | specified for the UL, |
| | | | | the first options |
| | | | | shall be used as |
| | | | | default for the DL. |
| | | | | As regards to the IE |
| | | | | “Channel type”, |
| | | | | rule is specified in |
| | | | | 8.6.4.8. |
| >>>Downlink transport channel | MP | | Enumerated | |
| type | | | (DCH, FACH, DSCH, | |
| | | | DCH + DSCH, | |
| | | | HS-DSCH, | |
| | | | DCH + HS- | |
| | | | DSCH) | |
| >>>DL DCH Transport channel | CV-DL- | | Transport | |
| identity | DCH | | channel | |
| | | | identity | |
| | | | 10.3.5.18 | |
| >>>DL DSCH Transport channel | CV-DL- | | Transport | |
| identity | DSCH | | channel | |
| | | | identity | |
| | | | 10.3.5.18 | |
| >>> Choice DL MAC-hs | CV-DL-HS- | | | |
| configuration | DSCH | | | |
| >>>>Normal | | | | |
| >>>>>DL HS-DSCH MAC-d flow | CV-DL-HS- | | MAC-d flow | |
| identity | DSCH | | identity | |
| | | | 10.3.5.7c | |
| >>>>Enhanced | | | | |
| >>>>>DL HS-DSCH MAC-d flow | | | DL enhanced | |
| identity | | | MAC-d flow | |
| | | | identity | |
| | | | 10.3.5.7f | |
| >>>Reordering queue ID | CV-DL-HS- | | Integer(1..8) | |
| | DSCH | | | |
| >>>DL MAC-hs configuration | CV-DL-HS- | | Enumerated | |
| | DSCH | | (Normal, | |
| | | | Enhanced) | |
| >>>DL RLC configuration | CV-DL-HS- | | Enumerated | |
| | DSCH | | (Normal, | |
| | | | Enhanced) | |
| >>>Logical channel identity | OP | | Integer(1..15) | 16 is reserved |

This IE is extended to support both normal and enhanced MAC-hs configurations. Based on the configuration, normal or enhanced, the MAC-hs sets up the MAC-hs queues accordingly.

For enhanced MAC-hs, more than one MAC-d can be mapped to a MAC-ehs queue. Therefore, to support more than one MAC-d flow, the IE should be extended to provide a list of MAC-d flows to be added or reconfigured to the queue. In the IE the MAC-d identity should support up to 16 MAC-d flows. The SID and N field configuration (ie. MAC-d PDU size info, MAC-d PDU size and index) are only provided for normal MAC-hs. Since the field is optional, the RRC may ensure that this information is not provided when MAC-hs configuration is set to normal. The fields may be placed as sub-sections of the normal MAC-hs configuration choice in the IE. The RRC procedure corresponding to actions upon receipt of “Added or reconfigured MAC-d flow” may be modified to only check for this field if MAC-hs configuration is set to normal. A definition of the IE “Added or reconfigured MAC-d flow” is shown in Table 3.

TABLE 3

| Information Element/Group | | | Type and | Semantics |
|---|---|---|---|---|
| name | Need | Multi | reference | description |
| MAC-hs queue to add or | OP | <1 to | | |
| reconfigure list | | maxQueueID> | | |
| >MAC-hs queue Id | MP | | Integer(0..7) | The MAC-hs queue |
| | | | | ID is unique across |
| | | | | all MAC-d flows. |
| >CHOICE DL MAC-hs | | | | |
| Configuration | | | | |
| >> enhanced | | | | |
| >>>MAC-d Flow to add or | | <1 to | | |
| reconfigure list | | maxMAC-d flow> | | |
| >>>>MAC-d Flow Identity | MP | | DL enhanced | |
| | | | MAC-d Flow | |
| | | | Identity | |
| | | | 10.3.5.7f | |
| > normal | | | | |
| >>MAC-d Flow Identity | MP | | MAC-d Flow | |
| | | | Identity | |
| | | | 10.3.5.7c | |
| >T1 | MP | | Integer(10, | Timer (in |
| | | | 20, 30, 40, 50, | milliseconds) when |
| | | | 60, 70, 80, 90, | PDUs are released |
| | | | 100, 120, 140, | to the upper layers |
| | | | 160, 200, 300, | even though there |
| | | | 400) | are outstanding |
| | | | | PDUs with lower |
| | | | | TSN values. |
| >MAC-hs window size | MP | | Integer(4, | |
| | | | 6, 8, 12, 16, | |
| | | | 24, 32) | |
| >MAC-d PDU size Info | OP | <1 to | | Mapping of the |
| | | maxMACdPDUsizes> | | different MAC-d |
| | | | | PDU sizes |
| | | | | configured for the |
| | | | | HS-DSCH to the |
| | | | | MAC-d PDU size |
| | | | | index in the MAC- |
| | | | | hs header. |
| >>MAC-d PDU size | MP | | Integer | |
| | | | (1..5000) | |
| >>MAC-d PDU size index | MP | | Integer(0..7) | |
| MAC-hs queue to delete list | OP | <1 to | | |
| | | maxQueueID> | | |
| >MAC-hs queue Id | MP | | Integer(0..7) | The MAC-hs queue |
| | | | | ID is unique across |
| | | | | all MAC-d flows. |

Alternatively, the MAC-d PDU size information and the associated MAC-d PDU size index can be placed as a sub-section of the “normal” DM MAC-hs configuration choice.

In addition to the definition of the information element, the actions related to the presence of this IE can also be modified. Optimizations of MAC-ehs headers are included in the present embodiment. The modification for MAC-d flow identity and the radio bearer (RB) mapping info IEs remain the same as stated above.

In order to support optimizations that handle fixed and flexible RLC PDU sizes differently based on logical channels the IE “Added or reconfigured MAC-d flow” should be modified. A field may be added to the “enhanced” DL MAC-hs configuration choice that indicates whether the corresponding MAC-d flow supports flexible or fixed RLC PDU size. Alternatively, the DL RLC configuration field from RB Mapping info IE can be used to check if the RLC supports flexible or fixed RLC PDU size. Also, if fixed RLC configuration is supported, then the RLC performs the actions associated with the mapping between MAC-d PDU sizes index and allowed MAC-d PDU sizes for that MAC-d flow. A possible definition of the IE is shown in Table 4 below.

TABLE 4

| Information Element/Group | | | Type and | Semantics |
|---|---|---|---|---|
| name | Need | Multi | reference | description |
| MAC-hs queue to add or | OP | <1 to | | |
| reconfigure list | | maxQueueID> | | |
| >MAC-hs queue Id | MP | | Integer(0..7) | The MAC-hs queue |
| | | | | ID is unique across |
| | | | | all MAC-d flows. |
| >CHOICE DL MAC-hs | | | | |
| Configuration | | | | |
| >> enhanced | | | | |
| >>>MAC-d Flow to add or | | <1 to | | |
| reconfigure list | | maxMAC-d flow> | | |
| >>>>MAC-d Flow Identity | MP | | DL enhanced | |
| | | | MAC-d Flow | |
| | | | Identity | |
| | | | 10.3.5.7f | |
| >>> >DL RLC configuration | | | Enumerated | |
| | | | (normal, | |
| | | | enhanced) | |
| >>>>MAC-d PDU size Info | OP | <1 to | | Mapping of the |
| | | maxMACdPDUsizes> | | different MAC-d |
| | | | | PDU sizes |
| | | | | configured for the |
| | | | | HS-DSCH to the |
| | | | | MAC-d PDU size |
| | | | | index in the MAC- |
| | | | | hs header. |
| >>>>>MAC-d PDU size | MP | | Integer | |
| | | | (1..5000) | |
| >>>>>MAC-d PDU size index | MP | | Integer(0..7) | |
| > normal | | | | |

The MAC-d PDU size information can be unique to the logical channel or unique to the group of logical channels corresponding to the given priority queue. In the latter case, the MAC-d PDU size information is not required per logical channel of that queue, as shown above, but rather per priority queue. In this case, the MAC-d flow identity would be in line with the other parameters of the queue, such as T1 and MAC-hs window size.

When the logical channels do not have a one to one mapping with the MAC-d flow, the logical channel identity is specified in the Iub frame protocol. In this case, the MAC-d flow identity and RB mapping info for Release 6 remain unchanged.

The mapping of logical channels and the MAC-hs queue is modified as described below. Specifically, the IE “added or reconfigured MAC-d flow” actions are conditioned by the choice of the MAC-hs configuration, that is, normal or enhanced. The choice is not restricted to the DL MAC-hs configuration. Any other available IE that indicates the version of MAC-hs can be used.

If enhanced MAC-hs configuration is used, the MAC-hs should map the list of logical channels provided to reordering queues. More than one logical channel can be mapped to one queue, therefore a field that contains a list of logical channels to add or reconfigure is provided to the enhanced MAC-hs configuration choice.

A new field, called “logical channels to add or reconfigure list”, ranges from 1 to maxLCH-ID, where maxLCH-ID is the maximum number of logical channels that can be mapped to the queue, or the maximum number of logical channels available. A logical channel identity is provided for each logical channel.

The modified IE “added or reconfigure MAC-d flow” is shown in Table 5, below. In order to support MAC-ehs header optimizations, where the MAC-ehs deals with fixed and flexible RLC PDU sizes, modifications similar to the ones set forth above should be performed. This includes the addition of a field that indicates what RLC configuration is supported for the given logical channel and/or MAC-d or logical size information per logical channel or per queue.

TABLE 5

| Information | | | | |
|---|---|---|---|---|
| Element/Group | | | | |
| name | Need | Multi | Type and reference | Semantics description |
| MAC-hs queue to add | OP | <1 to maxQueueID> | | |
| or reconfigure list | | | | |
| >MAC-hs queue Id | MP | | Integer(0..7) | The MAC-hs queue ID is unique |
| | | | | across all MAC-d flows. |
| >CHOICE DL MAC-hs | | | | |
| Configuration | | | | |
| >> enhanced | | | | |
| >>>Logical channels to | | <1 to maxLCH-ID> | | |
| add or reconfigure list | | | | |
| >>>> Logical Channel | MP | | Integer(1..15) | This parameter is used to distinguish |
| Identity | | | | logical channels multiplexed by MAC |
| | | | | on a transport channel. |
| > normal | | | | |
| >>MAC-d Flow | MP | | MAC-d Flow Identity | |
| Identity | | | 10.3.5.7c | |
| >T1 | MP | | Integer(10, 20, 30, 40, 50, | Timer (in milliseconds) when PDUs |
| | | | 60, 70, 80, 90, 100, 120, | are released to the upper layers even |
| | | | 140, 160, 200, 300, 400) | though there are outstanding PDUs |
| | | | | with lower TSN values. |
| >MAC-hs window size | MP | | Integer(4, 6, 8, 12, 16, 24, | |
| | | | 32) | |
| >MAC-d PDU size Info | OP | <1 to | | Mapping of the different MAC-d PDU |
| | | maxMACdPDUsizes> | | sizes configured for the HS-DSCH to |
| | | | | the MAC-d PDU size index in the |
| | | | | MAC-hs header. |
| >>MAC-d PDU | MP | | Integer | |
| size | | | (1..5000) | |
| >>MAC-d PDU | MP | | Integer(0..7) | |
| size index | | | | |
| MAC-hs queue to | OP | <1 to | | |
| delete list | | maxQueueID> | | |
| >MAC-hs queue | MP | | Integer(0..7) | The MAC-hs queue ID is |
| Id | | | | unique across all MAC-d |
| | | | | flows. |

If fixed RLC PDU sizes are supported for the logical channel then the system performs actions corresponding to the mapping of MAC-d index and MAC-d PDU size. In this case the MAC-d index and size corresponds to the given logical channel and the allowed RLC PDU sizes for this logical channel.

The actions related to the IE are similar to the ones set forth above, with the following changes. If the “DL MAC-hs configuration” is set to the value “enhanced” for each logical channel included in the IE “logical channel to add or reconfigure list” and if the WTRU has previously stored a mapping between this MAC-hs queue and this logical channel, the old mapping is deleted and the logical channel indicated in the current message is mapped to this MAC-hs queue.

Alternatively, a new IE element can be added. The new information element will serve the same purpose as the “added or reconfigured MAC-d flow” IE. The fields included in this IE can include a list of queue IDs and queue identity and a list of logical channel per queue and logical channel identity. Optionally, if MAC-hs header optimizations are included, a field indicating RLC configuration and SID and N information for every logical channel with fixed RLC PDU size. Also included may be a T1 timer, MAC-hs window size and queues to delete.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for processing flexible acknowledged mode (AM) protocol data unit (PDU) sizes comprising:
receiving radio link control (RLC) service data units (SDUs);
determining if RLC is configured for flexible PDU sizes; and
processing the RLC SDUs.

2. The method of claim 1, wherein the processing of RLC SDUs includes segmenting and/or concatenating RLC SDUs into acknowledged mode data (AMD) PDUs of fixed length and storing the AMD PDUs of fixed length in a transmission buffer if the RLC is not configured for flexible PDU sizes.

3. The method of claim 1, wherein the processing of RLC SDUs when the RLC is configured for flexible PDU sizes includes storing the RLC SDUs in a transmission buffer, receiving a request from lower layers, removing the RLC SDUs from the transmission buffer, and creating flexible PDUs.

4. The method of claim 3, wherein the received request is a request for N PDUs of size X.

5. The method of claim 3, wherein the received request is a request for a maximum amount of data.

6. The method of claim 3, wherein the received request is a request for a maximum RLC PDU size.

7. The method of claim 3, wherein the lower layers include a medium access control (MAC).

8. The method of claim 3, wherein the PDU size requested by lower layers is below a maximum value configured by higher layers.

9. The method of claim 3, wherein the PDU size requested by lower layers is above a minimum value configured by higher layers.

10. The method of claim 3, wherein a STATUS PDU is piggybacked when the sum of the sizes of buffered RLC SDUs is less than the maximum PDU size to be delivered to lower layers.

11. The method of claim 3, wherein a STATUS PDU is piggybacked when the size of a next RLC SDU to be transmitted is less than the maximum PDU size to be delivered to lower layers.

12. The method of claim 3, wherein a STATUS PDU is piggybacked when the concatenation of all buffered RLC SDUs with the STATUS PDU is less than the maximum PDU size to be delivered to lower layers.

13. The method of claim 3, wherein a STATUS PDU is piggybacked when the concatenation of the next RLC SDU with the STATUS PDU is less than the maximum PDU size determined by lower layers.

14. The method of claim 3, wherein length indicators are used to define whether a padding or a piggybacked STATUS PDU is included in the AMD PDU.

15. The method of claim 3, wherein length indicators are used to define the boundaries between RLC SDUs within AMD PDUs.

16. A wireless transmit/receive unit (WTRU) comprising:
a transmitter;
a receiver; and
a radio link control (RLC) configured to operate in acknowledged mode (AM) and process flexible size protocol data units (PDUs).

17. The WTRU of claim 16, wherein the RLC further comprises:
a transmitting side;
a receiving side; and
an RLC control unit configured to manage functions between the transmitting side and the receiving side.

18. The WTRU of claim 17, wherein the transmitting side further comprises:
a transmission buffer;
a segmentation/concatenation unit;
a RLC header addition unit;
a retransmission buffer and management unit;
a multiplexer (MUX);
a field setting unit configured to set fields in PDU header and piggybacked STATUS PDU; and
a ciphering unit.

19. The WTRU of claim 18 further comprising a second transmission buffer.

20. The WTRU of claim 18, wherein the segmentation/concatenation unit includes a segmentation buffer.

21. The WTRU of claim 17, wherein the receiving side further comprises:
a demultiplexing/routing unit;
a deciphering unit;
a reception buffer and retransmission management unit;
an RLC header removal and piggybacked information extraction unit; and
a reassembly unit.

22. A wireless transmit/receive unit comprising:
a transmitter;
a receiver; and
an interface between a receiving medium access control (MAC) sublayer and a receiving radio link control (RLC) sublayer configured to receive MAC protocol data units (PDUs), extract RLC PDUs, transfer RLC PDUs and indicate the PDU size to the RLC.

23. The WTRU of claim 22 wherein the size of the RLC PDUs is indicated using a MAC-DATA-Indication primitive.

24. The WTRU of claim 23, wherein the MAC-DATA-Indication primitive indicates the PDU size measured in bits.

25. The WTRU of claim 23, wherein the MAC-DATA-Indication primitive indicates the PDU size measured in octets.

26. The WTRU of claim 23, wherein the MAC-DATA-Indication primitive indicates a total size of an individual radio link control (RLC) protocol data unit (PDU) received.

27. The WTRU of claim 26, wherein the total size of the RLC PDU is measured in bits.

28. The WTRU of claim 26, wherein the total size of the RLC PDU is measured in octets.

29. The WTRU of claim 26, wherein the total size of the RLC PDU includes the sum of the sizes of individual RLC PDUs.

30. The WTRU of claim 26, wherein the MAC-DATA-Indication primitive indicates a size of a received transport block.

31. A wireless transmit/receive unit (WTRU) comprising:
a transmitter;
a receiver; and
an interface between a transmitting MAC sublayer and transmitting RLC sublayer configured to determine a maximum PDU size parameter at the MAC layer corresponding to the sum of all radio link control (RLC) protocol data units (PDUs) delivered to a medium access control (MAC) and indicate the maximum size parameter to the RLC layer.

32. The WTRU of claim 31, wherein the maximum size parameter is sent using a MAC-STATUS-Indication primitive.

33. The WTRU of claim 31, wherein the maximum size parameter is measured in bits.

34. The WTRU of claim 31, wherein the maximum size parameter is measured in octets.

35. The WTRU of claim 31, wherein the maximum size parameter is measured at every transmission time interval (TTI).

36. The WTRU of claim 31, wherein the maximum size parameter is measured at any fixed period of time.

37. The WTRU of claim 31, wherein the maximum size parameter is the amount of data the RLC can deliver until the next time a maximum size is indicated using the MAC-STATUS-Indication primitive.

38. The WTRU of claim 31, wherein the interface further comprises:
an N parameter and an X parameter when the MAC layer requests N PDUs of size X.

39. The WTRU of claim 31, wherein the interface further comprises:
circuitry configured to determine the maximum size parameter based on a data capacity of an air interface.

40. The WTRU of claim 37, wherein the interface further comprises:
circuitry configured to determine the data capacity of the air interface based on radio conditions and scheduling of user data.

41. A wireless transmit/receive unit (WTRU) comprising:
a processor configured to receive radio link control (RLC) service data units (SDUs);
a processor configured to determine if an RLC is configured for flexible PDU sizes; and
a processor configured to process the RLC SDUs.

42. The WTRU of claim 41, wherein the processing of RLC SDUs includes segmenting and/or concatenating RLC SDUs into acknowledged mode data (AMD) protocol data units (PDUs) of fixed length and storing the AMD PDUs of fixed length in a transmission buffer if the RLC is not configured for flexible PDU sizes.

43. The WTRU of claim 41, wherein the processing of RLC SDUs when the RLC is configured for flexible PDU sizes includes storing the RLC SDUs in a transmission buffer, receiving a request from lower layers, removing the RLC SDUs from the transmission buffer, and creating flexible PDUs

44. A wireless transmit/receive unit (WTRU) configured to process flexible acknowledged mode (AM) protocol data unit (PDU) sizes comprising:
receiving acknowledged mode data (AMD) and control protocol data units (PDUs);
performing a first determination of whether the RLC is configured for flexible PDU sizes;
processing the received AMD PDUs if the first determination is affirmative;
performing a second determination of whether a fixed PDU size has been configured by higher layers if the first determination is negative;
performing a third determination of whether the PDUs are of different size if the second determination is affirmative;
discarding the PDUs of different size if the third determination is affirmative;
processing the received AMD PDUs if the third determination is negative;
basing AMD PDU size on the first PDU received and performing a fourth determination of whether the PDUs are of different size if the second determination is negative;
discarding the PDUs of different size if the fourth determination is affirmative; and
processing the received AMD PDUs if the fourth determination is negative.
